(19) United States
(12) Patent Application Publication
(10) Pub. No.: US 2026/0057618 A1
(43) Pub. Date: Feb. 26, 2026

(54) Computer-Implemented Method for Determining and Calibrating a 3D Representation of a Robot Cell

(71) Applicant: ABB Schweiz AG, Baden (CH)

(72) Inventors: Nima Enayati, Mannheim (DE); Arne Wahrburg, Weiterstadt (DE); Debora Clever, Zwingenberg (DE); Rene Kirsten, Fernwald (DE); Mikael Norrlof, Norrköping (SE); Giacomo Spampinato, Västerås (SE); Morten Akerblad, Västerås (SE); Mattias Bjorkman, Västerås (SE); Florian Stuhlenmiller, Ladenburg (DE); Jianjun Wang, Apex, NC (US)

(73) Assignee: ABB Schweiz AG, Baden (CH)

(21) Appl. No.: 19/378,769

(22) Filed: Nov. 4, 2025

Related U.S. Application Data
(63) Continuation of application No. PCT/EP2023/061959, filed on May 5, 2023.

(51) Int. Cl. G06T 19/00; G06T 15/20

(52) U.S. Cl. CPC G06T 19/00; G06T 15/20

(57) ABSTRACT

A method for determining and calibrating a 3D representation of a robot cell includes a) obtaining cell data that includes environment data from a mobile sensor, wherein the environment data comprises a set of images of the robot cell from a first viewpoint; b) determining a 3D representation of the robot cell using the cell data; c) calibrating the 3D representation using a known geometry of the industrial robot; d) visualizing the 3D representation at the calibrated location and orientation in the robot cell in simulation software; e) determining the quality of the 3D representation; and f) repeating steps a)-e) when the quality of the 3D representation is smaller than a predetermined threshold.

### CROSS-REFERENCE TO RELATED APPLICATIONS

The instant application claims priority to International Application No. PCT/EP2026/061959, filed May 5, 2024, which is incorporated herein in its entirety by reference.

### FIELD OF THE DISCLOSURE

The present disclosure generally relates to a computer-implemented method for determining and calibrating a 3D representation of a robot cell.

### BACKGROUND OF THE INVENTION

Programming robots and simulating robotic applications requires information about the environment. The environment can be represented by modelling or importing 3D models of different objects, describing their shape, dimension and the location with respect to the robot base. This process is time-consuming for the user and needs to be performed again when the environment changes.

One alternative is to use sensors that scan the actual robot cell to create corresponding representations. To calibrate the generated 3D environment, i.e., ensure that the location and scale of the generated 3D environment is correctly represented in the simulation, different solutions exist: a) Sensors are mounted at known locations in the robot cell and calibration markers are used to specify the location and scale of the captured data with respect to the sensors' locations. Stationary sensors and markers are expensive hardware components if they remain in the robot cell or need to be remounted to account for changes in the environment; b) Sensors are mounted on the robot, which ensures that the environmental data is captured with respect to the location of the robot. However, the robot needs to move to scan the complete robot cell, which may result in a collision with objects not yet detected; and c) Simultaneous Localization And Mapping (SLAM) is a method for mobile robots, whereby a representation of the environment is generated during robot motions. SLAM requires algorithms to determine the location of the robot in the environment representation for the calibration of data captured from different locations.

The existing solutions only enable capturing data from specific areas depending on the type, location and number of sensors. To capture data of further areas of the environment or from different viewpoints, solution a) requires additional sensors or remounting effort, while solutions b) and c) require a motion of the robot. This may result in collisions with objects not yet detected.

### BRIEF SUMMARY OF THE INVENTION

The present disclosure generally addresses a need of an improved method for determining and calibrating a 3D representation of a cell. According to an aspect, a computer-implemented method for determining and calibrating a 3D representation of a robot cell, comprising an industrial robot in a work environment, in a simulation software, comprising the following steps. a) obtaining cell data of the robot cell, wherein the cell data comprises environment data from a mobile sensor, wherein the environment data comprises a set of images of the robot cell from a first viewpoint, wherein the set of images comprises one or more images. b) determining a 3D representation of the robot cell using the cell data. c) calibrating the 3D representation using a known geometry of the industrial robot, comprising identifying of a location, orientation and scale factor of the 3D representation with respect to the industrial robot. d) visualizing the 3D representation at the calibrated location and orientation in the robot cell in the simulation software; e) determining a quality of the 3D representation; repeating the steps a)-e) if the quality of the 3D representation is smaller than a predetermined threshold, wherein the environment data comprises a set of images of the robot cell from a second viewpoint, different from the first viewpoint.

### BRIEF DESCRIPTION OF THE SEVERAL VIEWS OF THE DRAWING(S)

FIG. 1 is a perspective view of a cell comprising an industrial robot in a work environment that is captured by a user in accordance with the disclosure.

FIG. 2 is a top view of a cell comprising an industrial robot in a work environment that is captured by a user from a first viewpoint in accordance with the disclosure.

FIG. 3 is a top view of a cell comprising an industrial robot in a work environment that is captured by a user from a first and second viewpoint in accordance with the disclosure.

FIG. 4 illustrates a top view of a cell comprising an industrial robot in a work environment that is captured by a user from a first, third and fourth viewpoint in accordance with the disclosure.

FIG. 5 is a flowchart for a method for determining and calibrating a 3D representation of a cell in accordance with the disclosure.

FIG. 6 is a diagram for a system for determining and calibrating a 3D representation of a cell, comprising an industrial robot in a work environment, in accordance with the disclosure.

### DETAILED DESCRIPTION OF THE INVENTION

The reference symbols used in the drawings, and their meanings, are listed in summary form in the list of reference symbols. In principle, identical assembly parts are provided with the same reference symbols in the figures.

Preferably, the functional modules and/or the configuration mechanisms are implemented as programmed software modules or procedures, respectively; however, one skilled in the art will understand that the functional modules and/or the configuration mechanisms can be implemented fully or assembly partially in hardware.

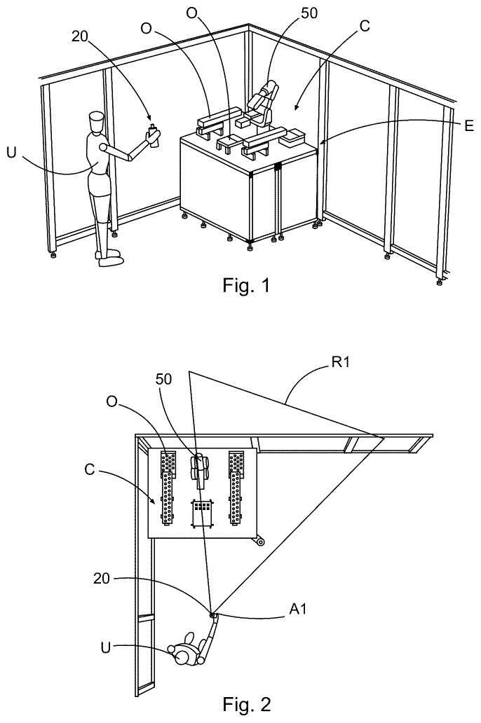

FIG. 1 illustrates a perspective view of a robot cell C, hereinafter referred to as cell, comprising an industrial robot 50 in a work environment E that is captured by a user U. In other words, the cell C comprises a workplace, in this case a table, on which the industrial robot 50 should perform actions on different objects O. The actions are preferably of logistics nature, i.e. moving the objects O from one location to another, and/or of manufacturing nature, i.e. combining different objects O with each other, for example by sticking one object into another.

In this case, the cell should be reflected by a simulation software, which consequently, needs a calibrated 3D representation of the cell to perform simulation tasks. To obtain cell data that reflect the objects O and the industrial robot 50, in particular their dimension and location, the user U uses a scanning device 20 comprising a mobile sensor to capture said cell data.

FIG. 2 illustrates a top view of a cell C comprising an industrial robot 50 in a work environment that is captured by a user U from a first viewpoint A1. A first region R1 indicates the region that is captured by the user U from the first viewpoint A1, when aligning the scanning device 20 in a first direction. The user U is guided, for example via a graphical user interface of a respective system, to capture cell data from a specific viewpoint, or in other words from a location with respect to the cell and a specific direction, for example an angle to a reference point, towards the cell. The location and the direction in which the mobile sensor is aligned is referred to as viewpoint. Thus, the user U uses the scanning device 20, in this case a mobile phone, and shoots a set of images of the cell from the first viewpoint A1. In this case, the set of images only contains one single image.

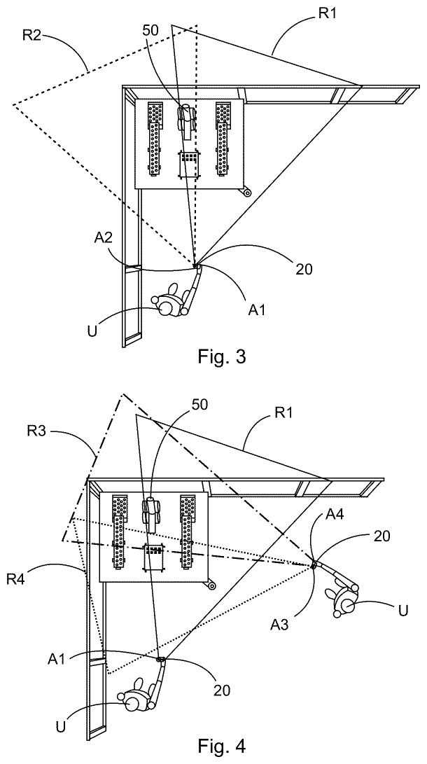

FIG. 3 illustrates a top view of a cell C comprising an industrial robot 50 in a work environment E that is captured by a user U from a first viewpoint A1 and second viewpoint A2. Compared to the scene in FIG. 2, the user U has been guided to capture cell data from an additional second viewpoint A2. In this case, the second viewpoint A2 is at the same location as the first viewpoint A1, but covers a second region R2, different than the first region R1, because the scanning device 20 is aligned in a second direction different than the first direction. This can be part of the initial data capturing. Alternatively, the user U can also be guided to capture the cell data from the second viewpoint A2 after it has been determined that the quality of the 3D representation of the cell in the simulation software based on the cell data from the first viewpoint A1 did not achieve sufficient quality. In this case, it has been determined that from the first viewpoint A1, not the whole cell has been captured, rendering the quality of the 3D representation insufficient. Thus, the user U is guided to acquire additional cell data from the second viewpoint A2. In this case, the second viewpoint comprises the same location as the first viewpoint A1 but comprises a different angel to the cell C.

FIG. 4 illustrates a top view of a cell comprising an industrial robot in a work environment that is captured by a user from a first viewpoint A1, a third viewpoint A3 and a fourth viewpoint A4. Compared to the scenario in FIG. 3, the third viewpoint A3 and the fourth viewpoint A4 comprise a different location as the first viewpoint A1. This example should indicate that between different iterations of obtaining cell data, a set of images that are acquired can also contain a plurality of images, in this case from the third viewpoint A3 and the fourth viewpoint A4. A third region R3 indicates the region that is captured by the user U from the third viewpoint A3, when aligning the scanning device 20 in a third direction. A fourth region R4 indicates the region that is captured by the user U from the fourth viewpoint A4, when aligning the scanning device 20 in a fourth direction. In this case, the third direction is different than the fourth direction. In other words, in this case, the user U was initially guided to acquire a first image from the first viewpoint A1. After it was determined that the cell data from the first viewpoint A1 did not achieve sufficient quality, the user U is guided to capture the cell data from the third viewpoint A3 and a fourth viewpoint A4.

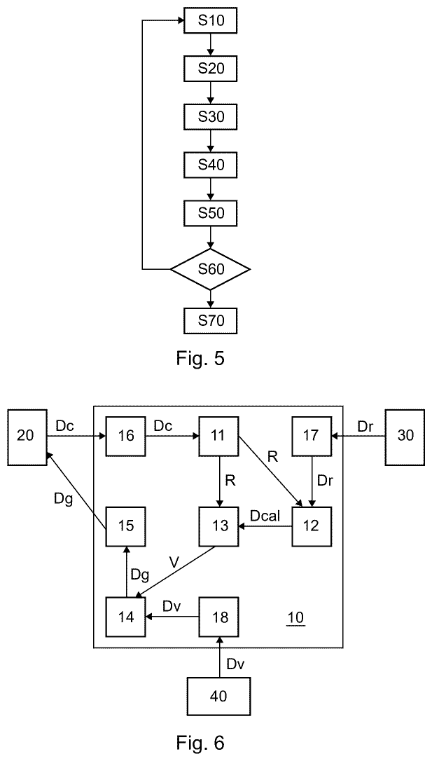

FIG. 5 illustrates schematically the method for determining and calibrating a 3D representation of a cell, comprising an industrial robot 50 in a work environment E, in a simulation software, comprising the following steps: obtaining S10, cell data Dc of the cell C, wherein the cell data Dc comprises environment data from a mobile sensor, wherein the environment data comprises a set of images of the cell C from a first viewpoint A1, wherein the set of images comprises one or more images; determining S20, a 3D representation R of the cell C using the cell data Dc; calibrating S30 the 3D representation R using a known geometry of the industrial robot 50, comprising identifying of a location, orientation and scale factor of the 3D representation R with respect to the industrial robot 50; visualizing S40 the 3D representation R at the calibrated location and orientation in the cell C in the simulation software; determining S50 the quality of the 3D representation R; repeating S60 the steps a)-e) if the quality of the 3D representation R is smaller than a predetermined threshold, wherein the environment data comprises a set of images of the cell C from a second viewpoint A2, different from the first viewpoint A1.

If the quality of the 3D representation R is higher than the predetermined threshold, in a step S70, it is indicated that the visualization of the 3D representation is final.

FIG. 6 illustrates schematically the system for determining and calibrating a 3D representation of a cell C, comprising an industrial robot 50 in a work environment E. The system comprises a processing device 10 and a scanning device 20. The scanning device 20 is configured to capture cell data Dc of the cell C. The processing device 100 comprises a first input interface 16, a second input interface 17, a third input interface 18, a determination unit 11, a calibration unit 12, a visualization unit 13, an evaluation unit 14 and a guide unit 15.

The first input interface 16 is configured to obtain cell data Dc of the cell, wherein the cell data Dc comprises environment data from a mobile sensor of the scanning device 20, wherein the environment data comprises a set of images of the cell C from a first viewpoint A1, wherein the set of images comprises one or more images. The cell data Dc are provided to the determination unit 11.

The determination unit 11 is configured to determine a 3D representation R of the cell C using the cell data Dc. The 3D representation R is provided to the calibration unit 12 and the visualization unit 13.

The calibration unit 12 is configured to calibrate the 3D representation R using a known geometry of the industrial robot 50, comprising identifying of a location, orientation, and scale factor of the 3D representation R with respect to the industrial robot 50. The geometry of the industrial robot 50 is provided to the calibration unit 12 via robot data Dr that are received by the second input interface 17 from a database 30. The calibration of the 3D representation R is reflected in calibration data D_{cal} that are provided to the visualization unit 13.

The visualization unit 13 is configured to visualize the 3D representation R at the calibrated location and orientation in the cell C in the simulation software using the calibration data Deal and the 3D representation R. The visualization V of the 3D representation R is provided to the evaluation unit 14.

The evaluation unit 14 is configured to determine the quality of the 3D representation by evaluating the visualization V of the 3D representation R. Preferably, the evaluation unit 14 is configured to provide guide data Dg to the user U, wherein the guide data Dg guides the user U to provide additional cell data to the processing device 10. The evaluation unit 14 is further configured to control the first input interface 16 to obtain the additional cell data after providing the guide data Dg to the user U. If the quality of the 3D representation is determined smaller than a predetermined threshold the first input interface 16 is configured to obtain the additional cell data, wherein the environment data of the additional cell data comprises a set of images of the cell from a second viewpoint, different from the first viewpoint.

To perform the evaluation, the evaluation unit 14 receives visual data Dv from an external camera through the third input interface 18. The visual data Dv reflects the whole cell C in one image. The evaluation unit 14 thus compares the visualization V of the 3D representation with the visual data Dv to determine the quality of the 3D representation.

Thus, the processing device 10 provides an iterative loop of obtaining cell data Dc from different viewpoints until the quality of the 3D representation is determined sufficient.

In the context of the present disclosure, the term “industrial robot”, as used herein, comprises a robot arm, which is preferably used for manufacturing or logistics, wherein the robot arm comprises a plurality of joints to provide a plurality of degrees of freedom. The term “set of images of the cell from a first viewpoint”, as used herein, relates to data of the cell from a first viewpoint provided by the mobile sensor. As such, the set of images comprises pixel data, for example in the case of the mobile sensor comprising a camera. Alternatively, the set of images comprises point clouds, for example in the case of the mobile sensor comprising a LIDAR sensor. Alternatively, the set of images comprises ultrasound data, for example in the case of the mobile sensor comprising an ultrasound sensor. In general, the set of images relates to any kind of data type that reflects the cell from a viewpoint, for example the first viewpoint, depending on the type of mobile sensor. The term “robot cell” is hereinafter also referred to as “cell”.

Preferably, the different viewpoints comprise information about a location of the mobile sensor and a direction, in which the mobile sensor, is aligned, in particular with respect to the robot cell.

The quality threshold is generally defined by the user while ensuring that environment data of the complete robot cell is captured.

The method thus allows to calibrate the location and scale of the 3D representations of the cell that is captured by a user with a mobile sensor. Thus, the generated 3D representation is based on the actual cell environment and can be generated before programming the industrial robot.

Preferably, the mobile sensor is comprised in a mobile device, in particular a mobile phone.

Different kinds of sensing are conceivable. For example, LIDAR technology in mobile devices or vision/stereo vision technology and other technologies can be employed as well. Preferably, the mobile sensor comprises a LIDAR sensor or a visual sensor.

In other words, the method allows guiding a user in capturing data with a mobile sensor while providing algorithms to calibrate the 3D environment representation with respect to a robotic system, so that the actual environment of the cell is correctly represented in the simulation software.

Thus, the method guides the user in capturing data with a mobile device (e.g. mobile phone). The user is instructed in capturing a sufficient amount of data from different viewpoints, covering the complete cell. In other words, the user is provided with a viewpoint that comprises a location from which at least part of the cell should be captured and a direction in which the mobile sensor should be facing. Alternatively, the viewpoint comprises the location from which at least part of the cell should be captured and an indication, which part of the cell should be captured. Thus, the user can adjust the direction of the mobile sensor, or in other words the mobile device comprising the mobile sensor, accordingly.

Thus, in order to determine the 3D representation, the cell data captured by the user is imported into a processing device, in particular running a simulation software and a 3D representation is generated. For example, one or several meshes are reconstructed from the obtained environment data of the cell data using existing algorithms. Alternatively, the user can manually create a 3D representation of the environment by placing meshes, for example boxes or spheres, on top of the cell data that to approximate the cell environment. While this requires manual effort by the user, the method preferably comprises the visualization of the obtained environment data in the simulation software as a valuable assistive tool. In addition, the user can decide which parts of the environment to model coarsely and where to apply a high level of detail.

Preferably, the 3D representation is visualized, or in other words displayed, by the simulation software via a graphical user interface that is configured to guide the user through the process of data capturing and preferably all further steps of the method.

Calibrating the 3D representation uses the known geometry of the industrial robot in the simulation software and preferably a known joint configuration during data capturing. Similarities in the 3D representation are found, e.g., by comparing meshes of the 3D representation and the known geometry. This allows an identification of the location, orientation, and scale factor of the 3D representation with respect to the robot base in the simulation and therefore the application. Alternatively, the 3D scan can merely be loaded into the simulation software as mentioned above. The calibrating orientation and location is then performed by the user, i.e., the scan is manually placed and scaled such that the robot geometry in the scan matches the geometry of the virtual robot.

For example, determining and calibrating the 3D representation comprises reconstructing a mesh from cell data in form of point clouds. Point clouds are preferably directly provided by a LIDAR sensor or can be determined from a plurality of 2D images. Alternatively, determining and calibrating the 3D representation comprises reconstructing the 3D representation and its location and/or orientation by performing pattern recognition on several images. Alternatively, determining and calibrating the 3D representation comprises performing matching the cell data to the known robot geometry to locate the robot geometry in the captured cell data.

Determining the quality of the 3D representation comprises evaluating an accuracy of the 3D representation and the calibration, for example, outliers are detected, and the coverage of the cell is analysed.

For example, when the cell data obtaining is finished, there may be a post processing called loop closure to readjust the stitching when the starting position and the end position of the different viewpoints are overlapped. Afterwards the 3D presentation can be generated. As the entire 3D representation can be calibrated using known geometries of the industrial robot, the robot/known geometries only need to be in several images of the plurality of iteratively obtained images to achieve good quality, but not in all images.

The method allows making robot programming in cluttered environments easier. When used in combination with a simulation software the method allows generating calibrated environmental models in which existing collision-free path planning can be applied. Alternatively, an implementation in the robot controller can be provided. In the latter case, the user would merely have to scan the cell and then teach the targets relevant to the application. With the calibrated environmental model and collision-free path planning, automatically creation of collision-free motions of the robot can be provided.

Consequently, an efficient method for determining and calibrating a 3D representation of a cell is provided that is directly coupled to a quality requirement of the 3D representation.

In a preferred embodiment, in at least one image of the set of images at least part of the industrial robot is covered. The industrial robot comprises at least one movable component. The cell data comprises robot arrangement data. The robot arrangement data comprises information about the arrangement of the at least one component. The 3D representation is calibrated using the known geometry of the industrial robot and the arrangement data.

In other words, in between iterations, the industrial robot can be moved so that more geometric features are captured by the user in the next iteration to improve the information of the cell data. Thus, a quality aspect comprising a comparison of the obtained cell data with the robot geometry is improved.

In a preferred embodiment, the industrial robot comprises at least one joint movably supporting the at least one movable component. The robot arrangement data comprises a joint configuration of the at least one joint.

For example, suitable joint configurations are generated, ensuring that the industrial robot only moves inside space that is covered by the 3D representation of the cell generated in the iteration before. This prevents a collision of the industrial robot with other objects of the cell, when moving.

To improve the calibration, preferably additional cell data is captured with different joint configurations for specific data capture locations, e.g., to have a side view of the industrial robot in the cell data. Suitable joint configurations and collision-free paths are generated ensuring that the motion to new joint configurations is constrained to areas of the generated 3D representation with sufficient accuracy and coverage. Constraining the motion to known areas can be achieved by for example representing unknown areas as virtual obstacles.

In other words, the method allows to regularly assess the quality, including the accuracy and coverage, of the 3D representation during generation and calibration of the 3D representation.

In a preferred embodiment, determining the quality of the 3D representation comprises detecting and discarding outliers in the cell data.

Preferably, the outliers are detected by dense fusion. Dense fusion comprises that a lot of images are taken in a small region from multiple view angles. Stitching all of the images creates an averaging effect for outlier removal. If new cell data, for example in form of images, are continuously added, the change in the average can be compared. If this change is below a specific threshold, it is known that the number of cell data is sufficient.

In a preferred embodiment, determining the quality of the 3D representation comprises evaluating a coverage of the robot cell by the 3D representation.

Visual inspection of the real cell and the visualized 3D representation and checking if the real cell is covered fully is an easy approach of determining the quality of the 3D representation. In this approach, it is only relevant that the full cell is covered rather than the quality of the objects being reflected with a specific accuracy. Thus, the quality of the 3D representation is defined by the amount of coverage of the cell.

In a preferred embodiment, determining the quality of the 3D representation comprises evaluating differences between the 3D representation of the industrial robot and known geometry of the industrial robot.

Thus, the quality of the 3D representation is defined by position/distance/angle difference of the known geometries as the indicator depending on the calibration and the difference in shape/volume between measured data and 3D representation.

In a preferred embodiment, determining the quality of the 3D representation comprises evaluating a density of points per cubic volume in the 3D representation.

Thus, the quality of the 3D representation is defined by a captured amount of cell data per cubic volume.

In a preferred embodiment, obtaining the environment data comprises guiding a user to capture the environment data using the mobile sensor.

Preferably, guiding the user comprises providing the user with guide data. Thus, after each iteration cycle of visualizing the 3D representation and evaluating the quality of the 3D representation, if the quality of the 3D representation does not satisfy a predetermined condition, additional cell data need to be obtained. Those additional cell data should be provided by the user using the mobile sensor. Thus, the user is provided with guide data, guiding the user to iteratively capture cell data from different locations and viewpoints, which preferably contain at least one known geometry, such as the static industrial robot or other known components of the cell.

In other words, during the iterative process of obtaining cell data, the user is guided in iteratively capturing data at different viewpoints until the representation is sufficiently accurate.

Preferably, the guide data is presented to the user via the mobile device. Alternatively, a display device is provided that displays a graphical user interface that is configured to guide the user through the process of data capturing and preferably all further steps of the method. Further preferably, the coverage of the robot cell that is already obtained is displayed. Thus, the user is visually informed how much coverage of the cell is already obtained.

In a preferred embodiment, the user is guided dependent on the evaluation of the quality of the 3D representation.

In other words, algorithms estimating the quality, for example accuracy of the 3D representation and coverage of the cell are used to guide the user in generating a precise environment representation that for example covers the complete cell with a satisfying quality.

In a preferred embodiment, obtaining the cell data comprises obtaining the cell data, wherein the at least one component of the industrial robot is arranged in different positions

The different positions, or in other words arrangements, are preferably determined so that as much area of a point of interest, for example the industrial robot, as possible is seen from the viewpoint of the user when capturing the cell data.

This allows to reduce the number of iterations to achieve a 3D representation with the demanded quality.

In a preferred embodiment, visualizing the 3D representation comprises highlighting differences between the 3D representation and the known geometry of the industrial robot.

The 3D representation is visualized at the calibrated location and orientation in the simulation software. Differences between the representation and existing geometries are highlighted, e.g., to visualize unmodeled changes of the environment after maintenance activities.

For example, highlighting comprises putting labels on the 3D representation to show which area needs to be rescanned, what locations should be scanned next, in which angle the scanner should aim at the scene. These labels and visual instructions are all generated by the quality metrics of the 3D representation.

In other words, the user is provided with information, which part of the cell needs to be captured and which part of the cell needs to be recaptured to satisfy quality requirements.

According to another aspect, a processing device is configured to carry out the method, as described herein.

In particular, the processing device comprises a first input interface, a determination unit, a calibration unit, a visualisation unit and an evaluation unit.

The first input interface is configured to obtain cell data of the cell, wherein the cell data comprises environment data from a mobile sensor, wherein the environment data comprises a set of images of the cell from a first viewpoint, wherein the set of images comprises one or more images. If the quality of the 3D representation is smaller than a predetermined threshold the first input interface is configured to obtain additional cell data, wherein the environment data of the additional cell data comprises a set of images of the cell from a second viewpoint, different from the first viewpoint.

The determination unit is configured to determine a 3D representation of the cell using the cell data.

The calibration unit is configured to calibrate the 3D representation using a known geometry of the industrial robot, comprising identifying of a location, orientation and scale factor of the 3D representation with respect to the industrial robot.

The visualisation unit is configured to visualize the 3D representation at the calibrated location and orientation in the cell in the simulation software.

The evaluation unit is configured to determine the quality of the 3D representation. Preferably, the evaluation unit is configured to provide guide data to the user, wherein the guide data should guide the user to provide additional cell data to the processing device. The evaluation unit is further configured to control the first input interface to obtain the additional cell data after providing the guide data to the user. In other words, the evaluation unit is configured to control the iterative loop of obtaining the cell data.

According to another aspect, a system for determining and calibrating a 3D representation of a robot cell comprises a robot cell, comprising an industrial robot in a work environment, a scanning device, comprising a mobile sensor configured to capture cell data and a processing device, configured to carry out the method as described herein.

According to another aspect, a computer program comprises instructions, which, when the program is executed by a computer, cause the computer to carry out the method as described herein.

According to another aspect, a computer-readable medium comprises instructions which, when executed by a computer, cause the computer to carry out the method, as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for determining and calibrating a 3D representation of a robot cell comprising an industrial robot in a work environment, and a simulation software, the method comprising:
a) obtaining cell data of the robot cell, wherein the cell data comprises environment data from a mobile sensor, wherein the environment data comprises a set of images of the robot cell from a first viewpoint, wherein the set of images comprises one or more images;
b) determining a 3D representation of the robot cell using the cell data;
c) calibrating the 3D representation using a known geometry of the industrial robot, comprising identifying of a location, orientation and scale factor of the 3D representation with respect to the industrial robot;
d) visualizing the 3D representation at the calibrated location and orientation in the robot cell in the simulation software;
e) determining a quality of the 3D representation; and
f) repeating steps a)-e) when the quality of the 3D representation is smaller than a predetermined threshold, wherein the environment data comprises a set of images of the robot cell from a second viewpoint that is different from the first viewpoint.

2. The method of claim 1, wherein in at least one image of the set of images at least part of the industrial robot is covered; wherein the industrial robot comprises at least one movable component; wherein the cell data comprises robot arrangement data, wherein the robot arrangement data comprises information about the arrangement of the at least one component; and wherein the 3D representation is calibrated using the known geometry of the industrial robot and the arrangement data.

3. The of claim 2, wherein the industrial robot comprises at least one joint movably supporting the at least one movable component; and wherein the robot arrangement data comprises a joint configuration of the at least one joint.

4. The method of claim 1, wherein determining the quality of the 3D representation comprises detecting and discarding outliers in the cell data.

5. The method of claim 1, wherein determining the quality of the 3D representation comprises evaluating a coverage of the robot cell by the 3D representation.

6. The method of claim 1, wherein determining the quality of the 3D representation comprises evaluating differences between the 3D representation of the industrial robot and known geometry of the industrial robot.

7. The method of claim 1, wherein determining the quality of the 3D representation comprises evaluating a density of points per cubic volume in the 3D representation.

8. The method of claim 1, wherein obtaining the environment data comprises guiding a user to capture the environment data using the mobile sensor.

9. The method of claim 8, wherein the user is guided dependent on the evaluation of the quality of the 3D representation.

10. The method of claim 2, wherein obtaining the cell data comprises obtaining the cell data, wherein the at least one component of the industrial robot is arranged in different positions.

11. The method of claim 1, wherein visualizing the 3D representation comprises highlighting differences between the 3D representation and the known geometry of the industrial robot.

12. A system for determining and calibrating a 3D representation of a robot cell, comprising:
an industrial robot disposed in a work environment;
a scanning device comprising a mobile sensor configured to capture cell data; and
a processing device configured to carry out a method for determining and calibrating a 3D representation of the robot cell, the method comprising:
a) obtaining cell data of the robot cell, wherein the cell data comprises environment data from a mobile sensor, wherein the environment data comprises a set of images of the robot cell from a first viewpoint, wherein the set of images comprises one or more images;
b) determining a 3D representation of the robot cell using the cell data;
c) calibrating the 3D representation using a known geometry of the industrial robot, comprising identifying of a location, orientation and scale factor of the 3D representation with respect to the industrial robot;
d) visualizing the 3D representation at the calibrated location and orientation in the robot cell in the simulation software;
e) determining a quality of the 3D representation; and
f) repeating steps a)-e) when the quality of the 3D representation is smaller than a predetermined threshold, wherein the environment data comprises a set of images of the robot cell from a second viewpoint that is different from the first viewpoint.

13. A computer program, comprising instructions which, when the program is executed by a computer, cause the computer to carry out a method for determining and calibrating a 3D representation of a robot cell comprising an industrial robot in a work environment, and a simulation software, comprising:
a) instructions for obtaining cell data of the robot cell, wherein the cell data comprises environment data from a mobile sensor, wherein the environment data comprises a set of images of the robot cell from a first viewpoint, wherein the set of images comprises one or more images;
b) instructions for determining a 3D representation of the robot cell using the cell data;
c) instructions for calibrating the 3D representation using a known geometry of the industrial robot, comprising identifying of a location, orientation and scale factor of the 3D representation with respect to the industrial robot;
d) instructions for visualizing the 3D representation at the calibrated location and orientation in the robot cell in the simulation software;
e) instructions for determining a quality of the 3D representation; and
f) instructions for repeating steps a)-e) when the quality of the 3D representation is smaller than a predetermined threshold, wherein the environment data comprises a set of images of the robot cell from a second viewpoint that is different from the first viewpoint.
